(19) United States
(12) Patent Application Publication
(10) Pub. No.: US 2026/0288282 A1
(43) Pub. Date: Sep. 24, 2026

(54) Pixel Refresh Rate Adjustment Based on Touch Detection

(71) Applicant: Apple Inc., Cupertino, CA (US)

(72) Inventors: Saman Saeedi, San Diego, CA (US); Amit Nayyar, Saratoga, CA (US); Sagar R Vaze, Santa Clara, CA (US); Kevin W Sliech, San Francisco, CA (US); Kyle D Sanner, San Jose, CA (US); Miryam Metzger, Netanya (IL); Vehbi Calayir, Santa Clara, CA (US); Assaf Menachem, Hod Hasharon (IL); Satheesha Krishna Muliyala, Cupertino, CA (US); Dileep Venkata Rao Madhava, Santa Clara, CA (US); Xinyu Yu, Campbell, CA (US); Jason C Hu, Palo Alto, CA (US)

(21) Appl. No.: 19/571,213

(22) Filed: Mar. 18, 2026

Related U.S. Application Data
(60) Provisional application No. 63/775,999, filed on Mar. 21, 2025.

(51) Int. Cl. G06F 3/041; G09G 3/20

(52) U.S. Cl. CPC G06F 3/04184; G09G 3/2092; G09G 2330/06; G09G 2340/0435; G09G 2354/00

(57) ABSTRACT

This disclosure is generally directed to touch detection and positioning on a surface of a display panel of an electronic device. The electronic device may throttle a refresh rate of pixels of the display panel in response to detecting presence of a touch without re-programming driver circuitry of the display panel. As such, the electronic device may determine positions of a detected touch by throttling the refresh rate of display without re-programming the driver circuitry. The electronic device may throttle the refresh rate by generating image frames of image data using multiple refresh cycles without re-programming the driver circuitry. Moreover, the electronic device may substantially maintain a line time of the pixels when throttling the refresh rate.

### CROSS-REFERENCE TO RELATED APPLICATIONS

This application claims priority to U.S. Provisional Application No. 63/775,999, filed Mar. 21, 2025, which is incorporated by reference herein in its entirety.

### SUMMARY

The present disclosure relates generally to electronic devices with an electronic display and, more particularly, to dynamically adjusting a refresh rate of the electronic display based on whether a touch is being detected on a surface of the electronic display.

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Numerous electronic devices—such as computers, mobile phones, wearable devices such as a watch, portable media devices, tablets, televisions, virtual-reality headsets, and vehicle dashboards, among many others—may have an electronic display including pixels and touch drive and touch sense electrodes. Such an electronic device may drive the pixels to display image data. The electronic device may drive the touch drive electrodes and detect touch sensing signals from the touch sense electrodes. The electronic device may detect an occurrence of a touch on a surface of the electronic display by processing the touch sensing signals. Subsequently, the electronic device may determine positions of the detected touch on the surface of the electronic display in response detecting presence of the touch. Although embodiments herein are described with respect to the touch sense electrodes, it should be appreciated that other sensors, including but not limited to proximity sensors, may additionally or alternatively receive and/or provide the touch sensing signals for detecting the occurrence of a touch on the surface of the electronic display.

The electronic device may drive the pixels during each refresh cycle having a duration based on a refresh rate. Moreover, the electronic device may drive the pixels during arbitrary presentation times and/or line times of the display panel. An arbitrary presentation time and/or line time may correspond to a time period for updating the pixels of the display panel during a refresh cycle based on the refresh rate. The electronic device may drive the pixels during a portion of each refresh cycle duration. As such, a duration of the arbitrary presentation time and/or line time may be equal to or less than a duration of a refresh cycle of the pixels. Moreover, the electronic device may drive the touch sense electrodes by generating the touch sense signals during vertical blanking intervals non-overlapping with the arbitrary presentation times and/or the line times during each refresh cycle of the pixels. Each refresh cycle may correspond to one or multiple clock cycles of a clock signal and/or one or multiple counts of a counter.

The electronic device may process the returned touch sense signals of the touch sense electrodes for detecting a touch faster than for determining positions of the touch. That is, the electronic device may detect a touch by processing touch sensing signals during a shorter time period compared to processing the touch sensing signals to determine positions of the touch. In some cases, a single refresh cycle duration may be insufficient for determining positions of a touch. For example, a remaining portion of each refresh cycle after or before driving the pixels during the arbitrary presentation time and/or line time may be insufficient to process the touch sensing signals for determining positions of the touch.

In such cases, the electronic device may drive the pixels and the touch sense electrodes during each refresh cycle when (e.g., only when) no touch is being detected on the surface of the electronic display. That is, the electronic device may generate and process the touch sense signals for touch detection without touch positioning. As such, the electronic device may drive the pixels using a higher refresh rate when no touch is being detected. For example, the display panel may display image data with improved quality.

In response to detecting a touch, the electronic device may drive the pixels during every other refresh cycle to lower (e.g., halve) the refresh rate. For example, every other refresh cycle may include an arbitrary presentation time and/or line time. As such, each vertical blanking interval may correspond to an expanded time duration including a portion of a time duration of a refresh cycle and a time duration (e.g., the entirety of) of a subsequent refresh cycle. That is, the electronic device may drive the touch sense electrodes and generate and process the touch sense signals during an expanded touch processing period.

The electronic device may continue driving the pixels during every other refresh cycle using the same (e.g., substantially the same) arbitrary presentation time and/or line time as when driving the pixels during each refresh cycle. The electronic device may continue determining positions of the detected touch while the touch is being detected. Moreover, the electronic device may return to driving the pixels during each refresh cycle using the higher refresh rate when the touch detection ends. For example, the electronic device may drive the pixels using the higher refresh rate in response to one or more touches being removed from the surface of the electronic display.

That is, the electronic device may dynamically adjust the refresh rate for driving the pixels based on touch detection while driving the pixels using a single refresh cycle. As such, the electronic device maintains a constant (e.g., nearly constant, relatively constant) arbitrary presentation time for updating the pixels of the display panel even when refreshing the pixels during every other refresh cycle. When the pixels are displaying the image data, the electronic device may reduce image artifacts on the display panel in response to detecting a touch while the pixels are being driven using the higher refresh rate. Alternatively or additionally, the electronic device may reduce occurrences of image artifacts based on using the single refresh cycle (e.g., not changing the refresh cycle or a counter value, a duration, or a frequency of the refresh rate) while a touch is being detected.

### BRIEF DESCRIPTION OF THE DRAWINGS

Various aspects of this disclosure may be better understood upon reading the following detailed description and upon reference to the drawings in which:

FIG. 1 is a block diagram of an electronic device with an electronic display;

FIG. 2 is a front view of a handheld device representing an example of the electronic device of FIG. 1;

FIG. 3 is a front view of another handheld device representing another example of the electronic device of FIG. 1;

FIG. 4 is a perspective view of a notebook computer representing an example of the electronic device of FIG. 1;

FIG. 5 illustrates front and side views of a wearable electronic device representing another example of the electronic device of FIG. 1;

FIG. 6 is a block diagram of an electronic display having an array of pixels controlled by display driver circuitry and touch sense electrodes controlled by touch sensing circuitry;

FIG. 7 is a timing diagram for detecting a touch on a surface of the electronic display of FIG. 6 by the touch sensing circuitry when the display driver circuitry drives the pixels based on a single programmed refresh rate of pixel driver circuitry, according to embodiments of the present disclosure;

FIG. 8 is a timing diagram for determining position of a touch on the surface of the electronic display of FIG. 6 in response to detecting a touch by driving the pixels based on a reduced refresh rate during every other refresh cycle of the programmed refresh cycle of the driver circuitry, according to embodiments of the present disclosure;

FIG. 9 is a process flow diagram for alternating between touch detection of FIG. 7 and touch positioning of FIG. 8 by adjusting the refresh rate of the pixels while driving the pixels using a single refresh cycle or a single line time, according to embodiments of the present disclosure; and

FIG. 10 is the timing diagram for alternating between touch detection and touch positioning on a surface of the electronic display of FIG. 6 by adjusting the refresh rate of the pixels while driving the pixels using the single line time and alternating between driving the pixels during each refresh cycle and every other refresh cycle of the programmed refresh cycle based on the process of FIG. 9, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

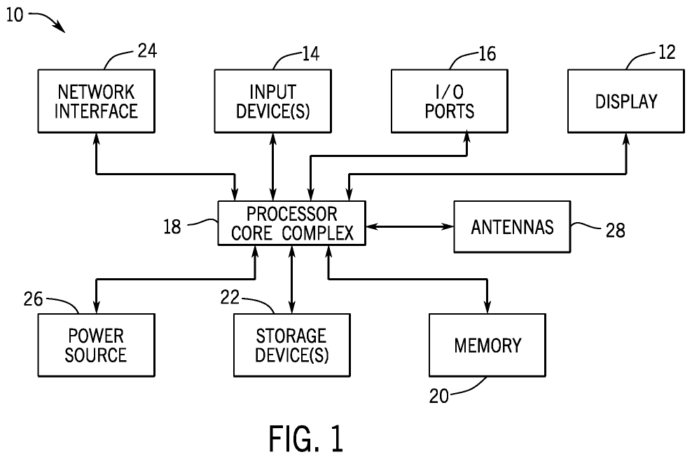

An electronic device 10 including an electronic display 12 (e.g., an electronic display circuit) is shown in FIG. 1. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 (e.g., processing circuitry) including one or more processor cores and/or controllers, local memory 20, a main memory storage device 22, a network interface 24, a power source 26 (e.g., power supply), and one or more antennas 28. The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network. The power source 26 may provide electrical power to one or more components in the electronic device 10, such as the processor core complex 18 or the electronic display 12. Thus, the power source 26 may include any suitable source of energy, such as a rechargeable lithium polymer (Li-poly) battery or an alternating current (AC) power converter. The I/O ports 16 may enable the electronic device 10 to interface with other electronic devices. For example, when a portable storage device is connected, the I/O port 16 may enable the processor core complex 18 to communicate data with the portable storage device.

The input devices 14 may enable user interaction with the electronic device 10, for example, by receiving user inputs via a button, a keyboard, a mouse, a trackpad, or the like. The input device 14 may include touch-sensing components (e.g., touch control circuitry, touch sense electrodes) disposed in the electronic display 12. The touch-sensing components may receive user inputs by detecting occurrence or position of an object touching the surface of the electronic display 12.

The electronic display 12 may include a display panel including pixel circuitry with an array of pixels and power supply circuitry with a number of independent supply tiles. The electronic display 12 may control light emission from the pixels to provide visual representations of information, such as a graphical user interface (GUI) of an operating system, an application interface, a still image, or video content, by displaying frames of image data. To display images, the electronic display 12 may include pixels implemented on the display panel. The pixels may represent sub-pixels that each control a luminance value of one color component (e.g., red, green, or blue for an RGB pixel arrangement or red, green, blue, or white for an RGBW arrangement).

The electronic display 12 may display an image by controlling light emission from its pixels based on image data associated with corresponding pixels in the image. In some embodiments, image data may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 12 may display frames based on image data generated by the processor core complex 18, or the electronic display 12 may display frames based on image data received via the network interface 24, an input device, or an I/O port 16.

The electronic device 10 may also have the one or more antennas 28 electrically coupled to the processor core complex 18. The antennas 28 may be configured in an omnidirectional or directional configuration, in a single-beam, dual-beam, or multi-beam arrangement, and so on. Each of the antennas 28 may be associated with one or more beams and various configurations. In some embodiments, multiple antennas of the antennas 28 of an antenna group or module may be communicatively coupled to the network interface 24 and each emit radio frequency signals that may constructively and/or destructively combine to form a beam. The electronic device 10 may include multiple transmitters, multiple receivers, multiple transceivers, and/or multiple antennas as suitable for various communication standards.

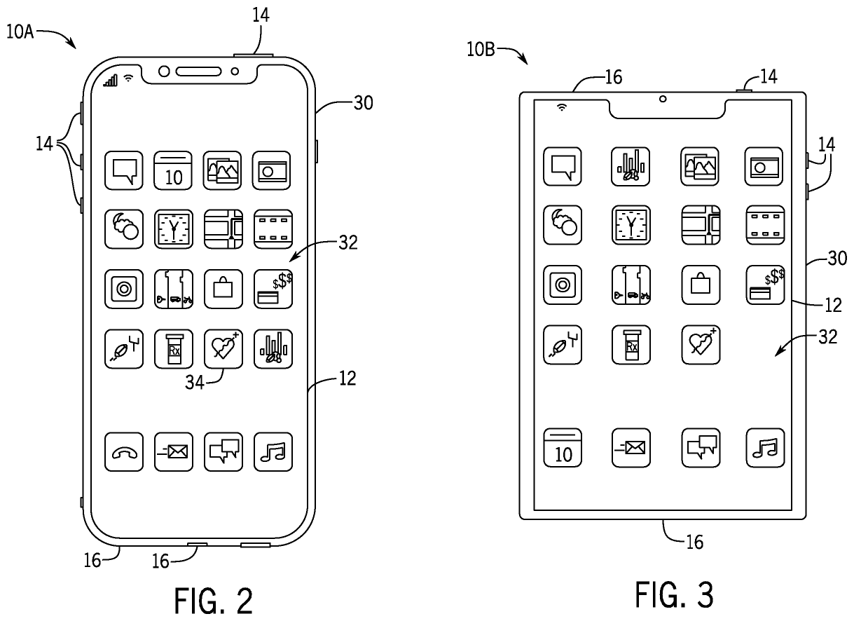

The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as any IPHONE model available from Apple Inc.

The handheld device 10A includes an enclosure 30 (e.g., housing). The enclosure 30 may protect interior components from physical damage or shield them from electromagnetic interference, such as by surrounding the electronic display 12. The electronic display 12 may display a graphical user interface (GUI) 32 having an array of icons. When an icon 34 is selected either by an input device 14 or a touch-sensing component of the electronic display 12, an application program may launch.

The input devices 14 may be accessed through openings in the enclosure 30. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

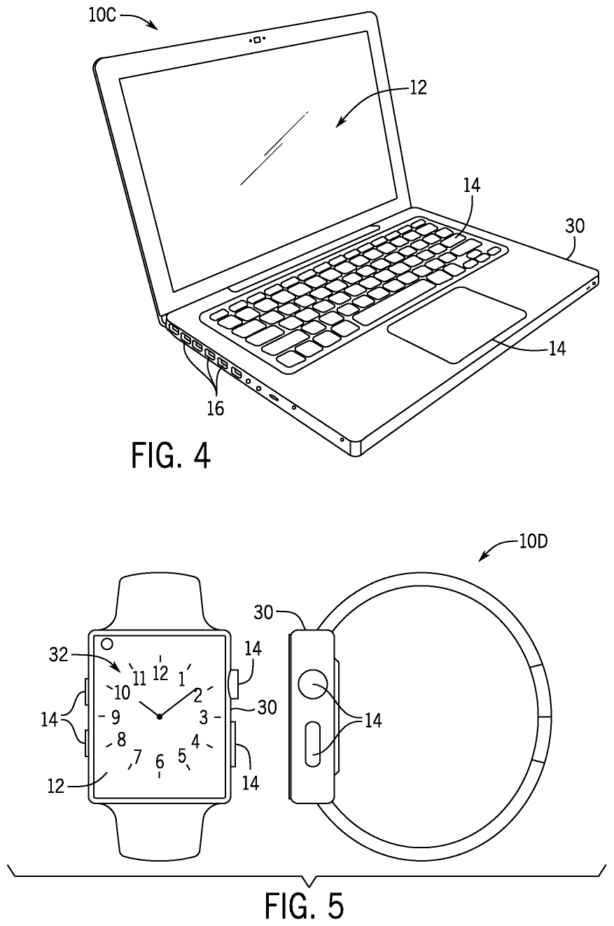

Another example of a suitable electronic device 10, specifically a tablet device 10B, is shown in FIG. 3. The tablet device 10B may be any IPAD model available from Apple Inc. A further example of a suitable electronic device 10, specifically a computer 10C, is shown in FIG. 4. For illustrative purposes, the computer 10C may be any MACBOOK or IMAC model available from Apple Inc. Another example of a suitable electronic device 10, specifically a watch 10D, is shown in FIG. 5. For illustrative purposes, the watch 10D may be any APPLE WATCH model available from Apple Inc.

As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed with respect to FIGS. 2 and 3.

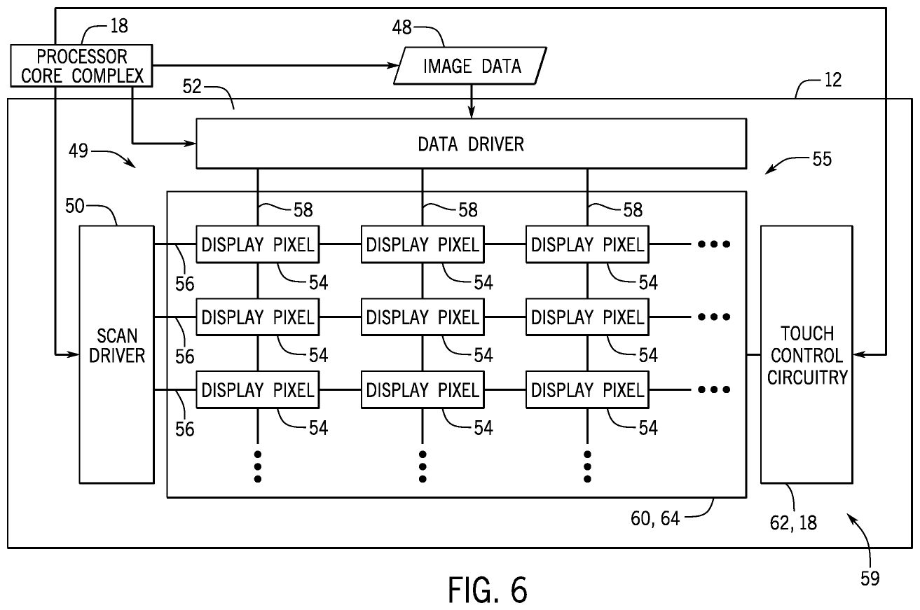

In FIG. 6, pixel circuitry of a display panel 60 associated with the electronic display 12 of the electronic device 10 is shown as an electronic display 12. The electronic display 12 may represent a liquid crystal display (LCD) or an organic light emitting diode (OLED) display. The electronic display 12 may receive image data 48 for display, for example, from the processor core complex 18. The electronic display 12 may include display driver circuitry 49 that includes scan driver 50 and data driver 52. Moreover, the electronic display 12 may include a display panel 60 having the pixels 54 disposed hereon. The processor core complex 18 may program the driver circuitry 49 to drive the pixels 54 using a refresh cycle (e.g., a single clock cycle). As such, the scan driver 50 and the data driver 52 may drive the image data 48 onto pixels 54 of an active area 55 during each or every other refresh cycle, as will be appreciated. The display panel 60 may also include power supply circuitry, such as the power source 26 discussed above, that provides supply voltage to the pixels 54.

The pixels 54 may each represent a liquid crystal (LC) cell to filter certain colors of light in various brightness levels from a backlight (not shown) or may contain one or more self-emissive elements, such as a light-emitting diodes (LEDs) (e.g., organic light emitting diodes (OLEDs) or micro-LEDs (μLEDs)). The pixels 54 may also represent pixels of digital mirror devices (DMD) or other suitable display devices that may use pixel grouping. In any event, different pixels 54 may emit different colors. For example, some of the pixels 54 may emit red light, some may emit green light, and some may emit blue light. Thus, the pixels 54 may be driven to emit light at different brightness levels to cause a user viewing the electronic display 12 to perceive an image formed from different colors of light. The pixels 54 may also correspond to hue and/or luminance levels of a color to be emitted and/or to alternative color combinations, such as combinations that use cyan, magenta, and yellow (CMY), or others.

The scan driver 50 may provide scan signals (e.g., pixel reset, data enable, on-bias stress) on scan lines 56 to control the pixels 54 by row. For example, the scan driver 50 may cause one or more selected rows of the pixels 54 to become enabled to receive a portion of the image data 48 from data lines 58 from the data driver 52. In this way, an image frame of the image data 48 may be programmed onto the pixels 54 row by row or selected groups of rows.

As mentioned above, the processor core complex 18 may program the driver circuitry 49 to drive the pixels 54 using a refresh cycle. As such, the driver circuitry 49, including the scan driver 50 and the data driver 52, may drive, program, or update the pixels 54 using the programmed refresh cycle. The processor core complex 18 may output the image data 48 to the driver circuitry 49 based on a duration of the refresh cycle to drive, program, or update the pixels 54 using the programmed refresh cycle. The driver circuitry 49 may receive the image data 48 to drive targeted pixels 54 using the programmed refresh cycle. Each refresh cycle may correspond to one or multiple clock cycles of a clock signal and/or one or multiple counts of a counter of the electronic device 10.

In some cases, the processor core complex 18 may generate and/or output the image data 48 during at least a portion of each refresh cycle. As such, a refresh rate of the electronic display 12 may correspond to the programmed refresh cycle of the driver circuitry 49. The refresh rate of the electronic display 12 may be indicative of a frequency for driving the image data 48 to update the pixels 54 of the display panel 60. In alternative or additional cases, the processor core complex 18 may generate and/or output image frames of the image data 48 during at least a portion of every other refresh cycle. In such cases, a refresh rate of the electronic display 12 may correspond to a frequency value half of that of the programmed refresh cycle. One or more clock generators, counters, oscillators, among other things, may be programmed to maintain a duration of the refresh cycle.

The driver circuitry 49 may drive each of the pixels 54 for updating each image frame of the image data 48 during each arbitrary presentation time. Moreover, the driver circuitry 49 may drive each line of the pixels 54 during a respective line time. A line time and an arbitrary presentation time of the display panel 60 may correspond to at least a portion of the duration of the refresh rate of the pixels 54. Each line of the pixels 54 may correspond to a single data line 58 or a single scan line 56. An arbitrary presentation time of the display panel 60 may include the line times of each line of the pixels 54 for updating the image frame of the image data 48. For example, the driver circuitry 49 may drive the pixels 54 during a portion of each refresh cycle or every other refresh cycle based on the image data 48. The portion of each refresh cycle or every other refresh cycle when the driver circuitry 49 drives the pixels 54 may correspond to an arbitrary presentation time of the display panel 60.

A touch sensing system 59 may be integrated into the electronic display 12 to enable touch functionality. The touch sensing system 59 includes touch sense electrodes 64 (e.g., touch sensing circuitry) to sense user input (e.g., user touches) and touch control circuitry 62 to control the touch sense electrodes 64. The touch sense electrodes 64 may be disposed with the display panel 60. The touch sense electrodes 64 and the pixels 54 may both be located within the active area 55. For example, the touch sense electrodes 64 may be disposed in relative proximity of the pixels 54.

It should be appreciated that the pixels 54 and the touch sense electrodes 64 are depicted by way of example. For example, in alternative or additional embodiments, the display panel 60 may include a different number of the pixels 54 with any other possible disposition within the active area 55. Moreover, the touch sense electrodes 64 may be formed by any suitable circuitry of the display panel 60 and/or have any viable disposition within the active area 55. By way of example, the pixels 54 may have circuitry including the touch sense electrodes 64.

The processor core complex 18 may include the touch control circuitry 62. The touch control circuitry 62 may drive the touch sense signals across or through the touch sense electrodes 64 of the display panel 60 and receive resulting touch sense signals. The touch sense signals may be indicative of whether an object is touching a surface of the electronic display 12 and/or positions of the object touching the surface of the electronic display 12. In some cases, the touch control circuitry 62 may detect occurrence of an object touching the surface of the electronic display 12 (e.g., a touch, a user input) by processing the touch sense signals. Alternatively or additionally, the touch control circuitry 62 may determine positions of one or more objects touching the surface of the electronic display 12 (e.g., one or more touches) by processing the touch sense signals, as will be appreciated.

It should be appreciated that in alternative or additional embodiments, the display panel 60 may include other sensors, including but not limited to proximity sensors in lieu or in addition to the touch sense electrodes 64. In such embodiments, the touch control circuitry 62 may drive the touch sense signals across or through the alternative or additional sensors. Moreover, such alternative or additional sensors may receive and/or provide the touch sensing signals for detecting the occurrence of the object touching the surface of the electronic display 12.

In some embodiments, the electronic display 12 may drive the pixels 54 and drive the touch sense electrodes 64 and the touch sense signals during non-overlapping time periods. For example, the electronic display 12 may reduce image artifacts caused by electromagnetic interference based on driving the pixels 54 and the touch sense signals during non-overlapping time periods. Moreover, as discussed above, the driver circuitry 49 may drive the pixels 54 during the arbitrary presentation times based on the refresh rate and/or the programmed refresh cycle. As such, the touch control circuitry 62 may generate the touch sense signals during remaining time periods non-overlapping with the arbitrary presentation times.

The touch control circuitry 62 may process the touch sense signals to detect a touch (e.g., a touch occurrence) without determining positions of the touch during first touch processing periods. The touch control circuitry 62 may process the touch sense signals to determine positions of the detected touch during greater touch processing periods compared to the first touch processing periods.

In some embodiment, the processor core complex 18 may generate and/or output the image data 48 during at least a portion of every other refresh cycle having the programmed refresh cycle in response to (e.g., subsequent to) touch detection. As such, the pixels 54 may receive subsequent image data 48 with increased remaining time periods in between. Moreover, the touch control circuitry 62 may generate the touch sense signals during the increased remaining time periods non-overlapping with the arbitrary presentation times. Accordingly, the touch control circuitry 62 may process the touch sense signals to determine positions of a detected touch before subsequently driving the touch sense signals across or through the touch sense electrodes 64 of the display panel 60.

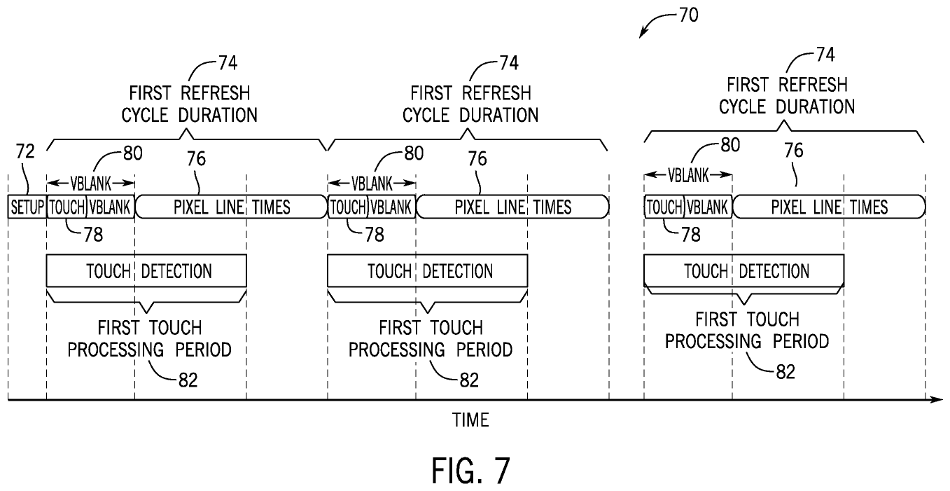

FIG. 7 is a timing diagram 70 illustrating touch detection when driving the pixels 54 based on a first refresh rate corresponding to a programmed refresh cycle of the driver circuitry 49, according to embodiments of the present disclosure. In the depicted embodiment, the processor core complex 18 may program the driver circuitry 49 to drive the pixels 54 using a refresh cycle during a setup period 72. Moreover, the processor core complex 18 may output image frames (e.g., a first set of image frames) of the image data 48 at the first refresh rate corresponding to the programmed refresh cycle of the driver circuitry 49. As such, the driver circuitry 49 may drive the pixels 54 during consecutive refresh cycles having the programmed duration.

For example, the first refresh rate may have a first frequency rate equal to or substantially equal to 60 hertz (Hz), 120 Hz, 160 HZ, 240 Hz, 480 Hz, 960 Hz, and so on, among other possibilities. Moreover, first refresh cycle durations 74 illustrate the consecutive refresh cycles of the first refresh rate. In the depicted embodiment, each of the first refresh cycle durations 74 include respective line times 76, a first vertical blanking interval 80, and a first touch processing period 82 to detect a touch 78. Each respective line times 76 may include a time period associated with updating line of the pixels 54 with an image frame of the image data 48.

The touch control circuitry 62 may generate and process the touch sense signals during first touch processing periods 82 of each first refresh cycle duration 74. For example, the touch control circuitry 62 may generate the touch sense signals during first vertical blanking intervals 80 that are non-overlapping with the line times 76 during each first refresh cycle duration 74. As such, the touch control circuitry 62 may drive the touch sense electrodes 64 and generate (e.g., cause generation of) and process the touch sense signals during each first touch processing period 82.

In some cases, the touch control circuitry 62 may generate and process the touch sense signals for touch detection without determining positions of a touch when refresh rate is equal to or higher than a refresh rate threshold. For example, the touch control circuitry 62 may detect a touch 78 faster than determining positions of the touch 78. Moreover, a duration of the first touch processing periods 82 may be sufficient for detecting a touch 78 but insufficient for determining the positions of the touch 78. As such, the touch control circuitry 62 may detect a touch 78 (e.g., a touch occurrence) without determining positions of the touch 78 when the refresh rate is equal to or higher than the refresh rate threshold. In such cases, the processor core complex 18 may adjust (e.g., lower, halve) the refresh rate for driving and/or updating the pixels 54 of the display panel 60 without re-programming the driver circuitry 49.

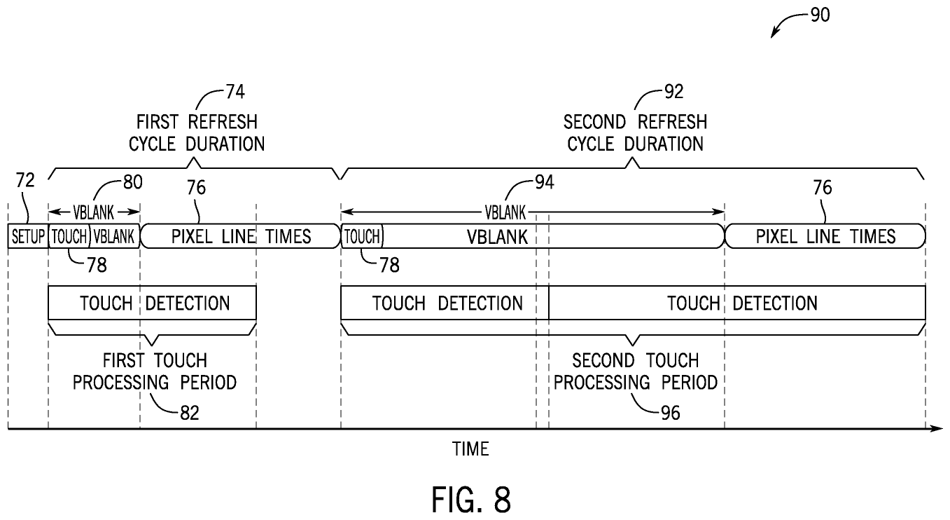

FIG. 8 is a timing diagram 90 for determining position of a touch in response to touch detection by driving the pixels 54 based on a reduced refresh rate during every other refresh cycle of a programmed refresh cycle of the driver circuitry 49, according to embodiments of the present disclosure. The processor core complex 18 may generate and/or output image frames (e.g., a second set of image frames) of the image data 48 using a second refresh rate less than the first refresh rate. For example, the processor core complex 18 may generate and/or output image frames of the image data 48 during every other refresh cycle of the programmed refresh cycle in response to detecting a touch 78. As such, the driver circuitry 49 may drive the pixels 54 during second refresh cycle durations 92 corresponding a duration of two consecutive refresh cycles of the programmed refresh cycle.

The second refresh cycle durations 92 illustrate the two consecutive refresh cycles of the second refresh rate. Each second refresh cycle duration 92 may include the respective line times 76, a second vertical blanking interval 94, and a second touch processing period 96 to detect a touch 78. A duration of arbitrary presentation times and/or the line times 76 may remain the same (e.g., nearly the same) compared to driving the pixels 54 using the first refresh rate. It should be appreciated that in alternative or additional embodiments, the processor core complex 18 and/or the driver circuitry 49 may provide the image data and/or drive the pixels 54 during a different fraction of the programmed refresh cycles.

The processor core complex 18 may generate and/or output image frames of the image data 48 using the second refresh rate without re-programming the driver circuitry 49. As mentioned above, the processor core complex 18 may program the driver circuitry 49 to drive the pixels 54 using a programmed refresh cycle during a setup period 72, for example, before the first refresh cycle durations 74. Moreover, the processor core complex 18 may not re-program the driver circuitry 49 in response to detecting the touch 78. As such, the duration of line times 76 may remain the same (e.g., substantially the same) based on the programmed refresh cycle of the driver circuitry 49 remaining the same. Accordingly, the processor core complex 18 may perform touch detection and touch positioning by adjusting the refresh rate of the pixels 54 while driving the pixels 54 using a single refresh cycle duration or a single line time 76.

In the depicted embodiment, the touch control circuitry 62 may generate and process the touch sense signals during second touch processing periods 96. Each second touch processing periods 96 may span over at least a portion of a second refresh cycle duration 92. Moreover, the second refresh cycle duration 92 may have an increased duration compared to the first refresh cycle duration 74. As such, the second touch processing period 96 may span over an increased (e.g., expanded) time period compared to the first touch processing period 82. For example, a duration of the second touch processing period 96 may be sufficient for determining positions of one or more touches 78. The touch control circuitry 62 may generate and process the touch sense signals for touch positioning during the second touch processing period 96. Accordingly, the processor core complex 18 may determine positions of a touch 78 in response to the initial detection of the touch 78.

It should be appreciated that the processor core complex 18 may generate and/or output image frames of the image data 48 using the second frame rate after any viable number of first refresh cycle durations 74. The processor core complex 18 may continue generating and/or outputting the image frames of the image data 48 using the second frame rate for any viable number of consecutive second refresh cycle durations 92, for example, while a touch 78 is present or is being detected on the surface of the electronic display 12. Moreover, the processor core complex 18 may switch back to generating and/or outputting the image frames of the image data 48 using the first frame rate 74 and/or alternate between generating and/or outputting the image frames of the image data 48 using any viable number of the first refresh cycle durations 74 and the second refresh cycle durations 92, for example, based on whether the touch 78 is being detected.

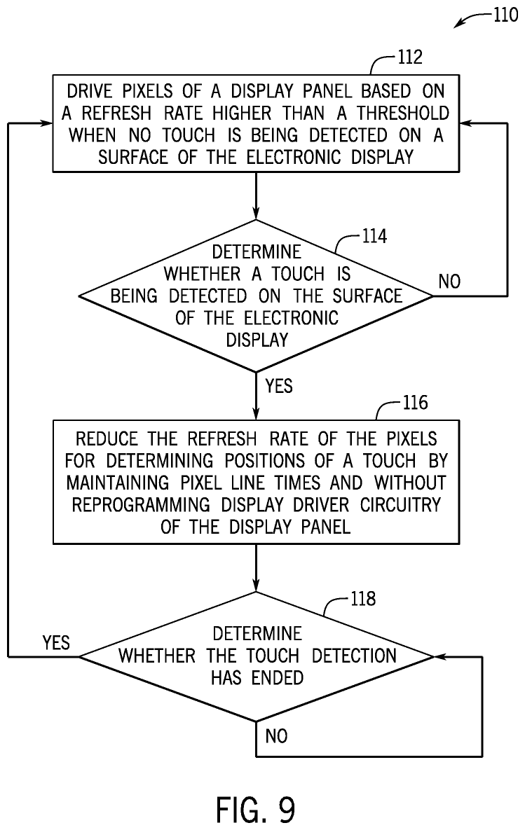

FIG. 9 is a process flow diagram 110 for alternating between touch detection and touch positioning by adjusting the refresh rate of the pixels 54 while driving the pixels 54 using a single refresh cycle (e.g., the programmed refresh cycle) or a single line time 76, according to embodiments of the present disclosure. Although the following description of the process 110 is described with reference to the processor core complex 18 of the electronic device 10, it should be noted that the process 110 may be partially or entirely performed by the driver circuitry 49, the touch control circuitry 62, and/or any other viable processor and/or controller. Additionally, although the following process 110 describes a number of operations that may be performed, it should be noted that the process 110 may be performed in a variety of suitable orders and all of the operations may not be performed. The process 110 may be implemented as instructions stored with one or more tangible, non-transitory, computer-readable media such as the local memory 20 and/or the main memory storage device 22 of the electronic device 10 discussed above.

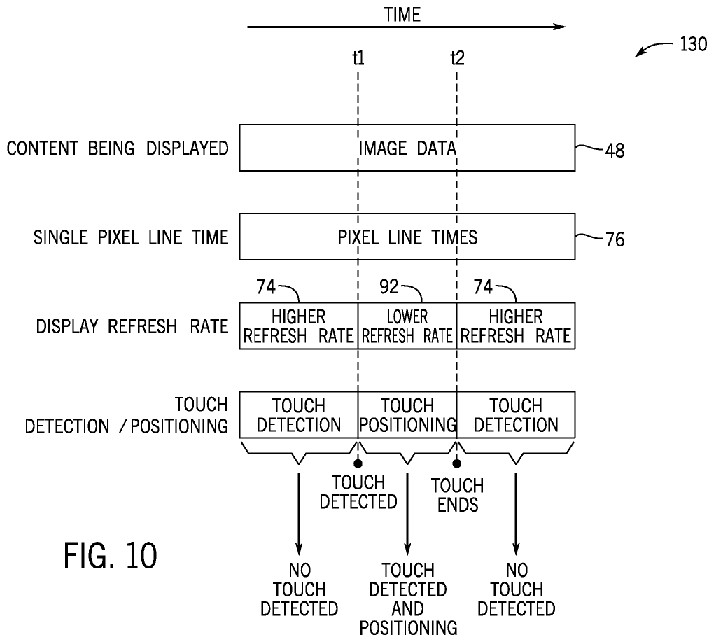

The process 110 of FIG. 9 may be described with respect to a timing diagram 130 of FIG. 10. FIG. 10 is the timing diagram 130 for alternating between touch detection and touch positioning on the surface of the electronic display 12 by adjusting the refresh rate of the pixels 54 while driving the pixels 54 using the single refresh cycle or the single line time 76, according to embodiments of the present disclosure. The processor core complex 18 may adjust the refresh rate of the pixels 54 while driving the pixels 54 using a single refresh cycle based on whether a touch is being detected on the surface of the electronic display 12. As mentioned above, the processor core complex 18 may program the driver circuitry 49 to drive the pixels 54 using a refresh cycle during a setup period 72, for example, before the first refresh cycle durations 74. Moreover, the processor core complex 18 may not re-program the driver circuitry 49 in response to detecting the touch 78. In some embodiments, the processor core complex 18 may include the driver circuitry 49 and/or the touch control circuitry 62.

At block 112, the processor core complex 18 and/or the driver circuitry 49 may drive the pixels 54 based on a refresh rate higher than the refresh rate threshold when no touch is being detected on the surface of the electronic display 12. For example, the processor core complex 18 and/or the driver circuitry 49 may drive the pixels 54 and the touch sense electrodes 64 during each refresh cycle when no touch is being detected on the surface of the electronic display 12. A time duration before a first time t1 in the timing diagram 130 of FIG. 10 illustrates an example time when the processor core complex 18 and/or the driver circuitry 49 drive the pixels 54 and the touch sense electrodes 64 during each refresh cycle. For example, the driver circuitry 49 may drive the pixels 54 with a refresh rate (e.g., a higher refresh rate) corresponding to (e.g., equal to) the single refresh cycle equal to or higher than the refresh rate threshold. As such, the electronic device may drive the pixels 54 using a higher refresh rate when no touch is being detected. In some cases, the display panel 60 may display image data 48 discussed above with improved quality. The display panel 60 may display contents of an application based on the image data 48, as shown in FIG. 10.

Moreover, the touch control circuitry 62 may drive the touch sense electrodes 64 and generate and process the touch sense signals during a touch processing period in between the line times 76 of each first refresh cycle duration 74 discussed above. In some cases, the touch processing period of block 112 may correspond to the first touch processing period 82 discussed above with respect to FIG. 7. The touch control circuitry 62 may not process the touch sense signals for determining touch positions before detecting a touch. For example, a duration of the first touch processing periods 82 may be insufficient to process the touch sensing signals for determining positions of a touch.

At block 114, the processor core complex 18 may determine whether a touch is being detected on the surface of the electronic display 12 when driving the pixels 54 and the touch sense electrodes 64 during each refresh cycle. The processor core complex 18 may return to (e.g., continue with) operation of block 112 when no touch is being detected on the surface of the electronic display 12. For example, the processor core complex 18 may determine whether a touch is being detected on the surface of the electronic display 12 continuously or repeatedly with or without a delay when driving the pixels 54 and the touch sense electrodes 64 during each refresh cycle at block 112. The processor core complex 18 may proceed to operations of block 116 in response to detecting one or more touches on the surface of the electronic device 12.

At block 116, the processor core complex 18 may reduce (e.g., throttle) the refresh rate to determine positions of a touch in response to detecting the touch on the surface of the electronic display 12. The processor core complex 18 may reduce the refresh rate of the electronic display to determine positions of one or more touches in response to detecting an occurrence of a touch when the pixels 54 are displaying image data 48 and the refresh rate is higher than the refresh rate threshold. The first time t1 in the timing diagram 130 of FIG. 10 illustrates an example time when a touch is detected (e.g., a touch 78 shown in FIG. 8). For example, the processor core complex 18 may reduce the refresh rate without changing the clock frequency or the line times 76 in response to detecting the touch at the first time t1. In some cases, the reduced refresh rate may correspond to the second refresh rate discussed above with respect to the second refresh cycle duration 92 of FIG. 8. Moreover, the driver circuitry 49 may drive the pixels 54 during line times 76 of every other refresh cycle to lower (e.g., halve) the refresh rate.

As discussed above, the touch control circuitry 62 may drive the touch sense electrodes 64 and generate the touch sense signals during non-overlapping time periods with the line times 76. Moreover, the second refresh cycle duration is longer than the first refresh cycle duration 74. As such, the second touch processing periods 96 (shown in FIG. 8) may be increased at block 116 of FIG. 9 in response to detecting the touch at the first time t1 (shown in FIG. 10). In particular, the second touch processing periods 96 may span over an increased (e.g., expanded) time period compared to a first touch processing period 82. That is, the touch control circuitry 62 may drive the touch sense electrodes 64 and generate and process the touch sense signals during an expanded touch processing period (e.g., the second touch processing period 96). Accordingly, the touch control circuitry 62 may determine positions of one or more touches on the surface of the electronic device 12 based on having the expanded touch processing period.

At block 118, the processor core complex 18 may determine whether the touch detection has ended when the refresh rate is reduced. For example, the touch control circuitry 62 may determine whether the touch detection has ended continuously or repeatedly with or without a delay. The processor core complex 18 and/or the driver circuitry 49 may continue driving the pixels 54 based on the reduced refresh rate when at least one touch is being detected on the surface of the electronic display 12. As such, the processor core complex 18 (e.g., the touch control circuitry 62) may continue generating and processing touch sense signals to determine positions of the one or more touches.

Additionally, the processor core complex 18 may return to block 112 for driving the pixels 54 using the higher refresh rate when the touch detection ends. A second time t2 in the timing diagram 130 of FIG. 10 illustrates an example time when the touch detection ends. After the second time t2, the driver circuitry 49 may drive the pixels 54 based on the initial refresh rate using the single refresh cycle and/or the single line time 76. Moreover, the touch control circuitry 62 may generate and process touch sense signals for touch detection without touch positioning. Accordingly, the processor core complex 18 may adjust the refresh rate for driving the pixels 54 based on touch detection while driving the pixels 54 using the single clock frequency and/or the single line time 76.

It should be appreciated that each portion of the process 110 of FIG. 9 and/or the timing diagram 130 of FIG. 10 may span over a different time period in different cases. Moreover, the process 110 of FIG. 9 and/or the timing diagram 130 of FIG. 10 may repeat any number of times based on touch detection and/or an end of the touch detection.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

Moreover, techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. An electronic device comprising:
an electronic display comprising a plurality of pixels; and
processing circuitry coupled to the electronic display, wherein the processing circuitry is configured to:
output a first set of image frames to at least a portion of pixels of the plurality of pixels during a single pixel line time of each refresh cycle duration;
detect whether a touch is present on a surface of the electronic display; and
output a second set of image frames to the portion of pixels during the single pixel line time of every other refresh cycle duration based on the touch.

2. The electronic device of claim 1, wherein the processing circuitry is configured to output the second set of image frames the portion of pixels during each refresh cycle duration based on not detecting the touch.

3. The electronic device of claim 1, wherein the processing circuitry is configured to detect whether the touch is present on the surface of the electronic display while outputting the first set of image frames.

4. The electronic device of claim 1, wherein the processing circuitry is configured to determine positions of the touch on the surface of the electronic device based on while outputting the second set of image frames to the portion of pixels.

5. The electronic device of claim 1, wherein the electronic display comprises a plurality of touch sense electrodes.

6. The electronic device of claim 5, wherein the processing circuitry is configured to drive at least a portion of touch sense electrodes of the plurality of touch sense electrodes during a first touch processing period to detect whether the touch is present.

7. The electronic device of claim 6, wherein the processing circuitry is configured to drive at least the portion of touch sense electrodes of the plurality of touch sense electrodes during a second touch processing period to determine positions of the touch, wherein the second touch processing period is increased compared to the first touch processing period.

8. An electronic display circuit comprising:
a plurality of pixels;
a plurality of touch sense electrodes;
processing circuitry coupled to the plurality of pixels and the plurality of touch sense electrodes, wherein the processing circuitry is configured to:
output a first set of image frames to the plurality of pixels during a single pixel line time of each refresh cycle duration based on a touch not being detected on a surface of the electronic display circuit;
output a second set of image frames to the plurality of pixels during the single pixel line time of every other refresh cycle duration based on the touch being detected; and
drive the plurality of touch sense electrodes during time periods non-overlapping with the single pixel line time of every other refresh cycle duration based on the touch being detected.

9. The electronic display circuit of claim 8, wherein the processing circuitry is configured to output the second set of image frames and drive the plurality of touch sense electrodes during time periods non-overlapping with the single pixel line time of each refresh cycle duration based on the touch not being detected.

10. The electronic display circuit of claim 8, wherein the processing circuitry is configured to detect whether the touch is present based on driving the plurality of touch sense electrodes during every other refresh cycle duration.

11. The electronic display circuit of claim 8, wherein the processing circuitry is configured to determine positions of the touch based on driving the plurality of touch sense electrodes during each refresh cycle duration.

12. The electronic display circuit of claim 11, wherein the processing circuitry is configured to determine positions of the touch after the touch is initially detected.

13. The electronic display circuit of claim 8, wherein the processing circuitry is configured to determine positions of the touch during an increased touch processing period based on outputting the second set of image frames during every other refresh cycle duration.

14. The electronic display circuit of claim 8, wherein the processing circuitry comprises display driver circuitry and touch control circuitry, wherein the display driver circuitry is coupled to the plurality of pixels, and the touch control circuitry is coupled to the plurality of touch sense electrodes.

15. Tangible, non-transitory, computer-readable media storing instructions that, when executed by processing circuitry, cause the processing circuitry to:
output a first set of image frames to a plurality of pixels of an electronic display during a single pixel line time of each refresh cycle duration;
detect whether a touch is present on a surface of the electronic display while outputting the first set of image frames;
output a second set of image frames to the plurality of pixels during the single pixel line time of every other refresh cycle duration in response to presence of the touch; and
determine positions of the touch while outputting the second set of image frames.

16. The tangible, non-transitory, computer-readable media of claim 15, wherein the instructions cause the processing circuitry to output a third set of image frames to the plurality of pixels during the single pixel line time of each refresh cycle duration in response to an end of the presence of the touch.

17. The tangible, non-transitory, computer-readable media of claim 15, wherein the instructions cause the processing circuitry to drive a plurality of touch sense electrodes of the electronic display during each refresh cycle duration while outputting the first set of image frames.

18. The tangible, non-transitory, computer-readable media of claim 15, wherein the instructions cause the processing circuitry to drive a plurality of touch sense electrodes of the electronic display during an increased touch processing period when outputting the second set of image frames compared to when outputting the first set of image frames.

19. The tangible, non-transitory, computer-readable media of claim 15, wherein the instructions cause the processing circuitry to drive a plurality of touch sense electrodes of the electronic display during time periods non-overlapping with the single pixel line time of each refresh cycle duration while outputting the first set of image frames.

20. The tangible, non-transitory, computer-readable media of claim 15, wherein the instructions cause the processing circuitry to drive a plurality of touch sense electrodes of the electronic display during time periods non-overlapping with the single pixel line time of every other refresh cycle duration while outputting the second set of image frames.
